(19) United States
(12) Patent Application Publication
(10) Pub. No.: US 2004/0239942 A1
(43) Pub. Date: Dec. 2, 2004

(54) Optical coherence tomography device

(76) Inventor: Chi-Kuang Sun, Taipei (TW)

Correspondence Address: BIRCH STEWART KOLASCH & BIRCH, PO BOX 747, FALLS CHURCH, VA, 22040-0747, US

(21) Appl. No.: 10/683,697

(22) Filed: Oct. 14, 2003

(30) Foreign Application Priority Data
May 30, 2003 (TW) 92114694

(51) Int. Cl. G01B 9/02

(52) U.S. Cl. 356/479

(57) ABSTRACT

A sub-micrometer-resolution optical coherence tomography device. The device, for measuring an object, comprises a light source emitting short wavelength light, converted to a first beam with a broad wavelength spectrum by passage through phosphor, an interferometer splitting the first beam into a second beam and a third beam, and a reflective mirror reflecting the second beam to create a reference beam. The third beam is reflected by the object to create a fourth beam, interferometrically combined with the reference beam in the interferometer to generate interference fringes. Due to the broad wavelength spectrum, ultra-short coherence length is obtained, providing ultra-high resolution of sub-micrometer scale.

### BACKGROUND OF THE INVENTION

1. Field of the Invention

The present invention relates to an optical coherence tomography device and in particular to an optical coherence tomography device having a light source with broad wavelength spectrum providing sub-micrometer resolution.

2. Description of the Related Art

In a conventional optical coherence tomography (OCT) device, a light beam is emitted from a light source and split by an interferometer into two beams. One beam is directed, by, for example, optical fiber, into skin, organs, or other measurement object and reflected by the same, the other split beam is reflected by a mirror to act as a reference beam, and the beam reflected by the measurement object is interferometrically combined with the reference beam to obtain an optical signal. The optical signal is received by a photo detector and converted to an electronic signal, then processed to produce 2-dimensional video images on a computer display.

U.S. Pat. No. 5,459,570(Swanson et al., 1995) discloses OCT used in ophthalmology, enabled by transparency of the eye. Proto-instrumentation for OCT used in skin inspection was successfully developed by Dr. Julia Welzel and the laser medicine center of Lübeck University in 1998.

OCT provides one kind of Optical Biopsy. Inspection by OCT may be repeated, rather than the one-time limitation of slide inspection. OCT provides higher resolution (traverse resolution of 10 μm and longitudinal resolution 10 μm) than ultrasonic inspection's resolution of 50 μm. However, for more precise inspection, OCT resolution must still be improved, and preferably to sub-micrometer scale.

OCT is based on optical interference, thus the resolution of the OCT is given by the equation:

l_{c}=0.44×(λ₀²/Δλ)

wherein l_{c} is the coherence length (resolution), λ₀ the optical wavelength of the light source and Δλ the spectral width of the light source.

For broader bandwidth, higher penetration, optimal energy and more stable radiation intensity are preferred. As well, in application, low cost, simple structure, easy operation and low peak energy power are preferred. Recently, light sources with various bandwidths and ultra-short wavelength pulse radiation source have been used to improve OCT resolution. For example, an ultra-broad bandwidth radiation can be obtained by mode-locked solid state lasers and particular optical fibers, with maximum resolution thereof reaching 0.75 μm. OCT utilizing complex laser sources to obtain high resolution is disclosed in U.S. Pat. No. 6,538,817. However, this technique entails cumbersome system parameters, higher costs and peak energy power that damages the inspection object during process.

Low-coherence light source, e.g. light emitting diode (LED), super-luminescent LD (SLD), super-fluorescent light source, are preferred due to their compact structure, low cost and no damage of the inspection object.

### SUMMARY OF THE INVENTION

Accordingly, an object of the invention is to provide an optical coherence tomography device enabling sub-micrometer resolution.

In the invention, a blue or ultraviolet LED emits light through suitable phosphor to produce low-coherent light beam with broad wavelength spectrum. Spectrum width of the light source can reach hundreds of nanometers, even into infrared range. In optical interference, ultra-short coherence time corresponds to ultra-short coherence length so that the longitudinal resolution can reach sub-micrometer scale.

The optical coherence tomography device of the invention comprises a light source emitting short wavelength light, converted to a first beam with a broad wavelength spectrum by passage through phosphor, an interferometer splitting the first beam into a second beam and a third beam and a reflective mirror reflecting the second beam to act as a reference beam. The third beam is reflected by the object to create a fourth beam interferometrically combined with the reference beam in the interferometer, resulting in interference fringes applied as an optical signal.

The light source in the invention can be an LED emitting blue light or ultraviolet rays. For example, the first beam can be produced by a GaN LED emitting blue light through YAG phosphor, or by an LED emitting ultraviolet through phosphor resulting in red, blue and green light. An LED directly emitting white light can also be used.

The optical coherence tomography device of the invention further comprises a detector converting the optical signal to an electronic signal processed by a signal processing unit.

As the radiation source in the invention provides a broader wavelength spectrum than conventional means, an ultra-short coherence length is created, such that very high resolutions (sub-micrometer) can be achieved.

A detailed description is given in the following embodiment with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a conventional optical coherence tomography device;

FIG. 2 is a schematic view of a conventional Michelson interference system;

FIG. 3 is a diagram of the interference intensity of conventional OCT versus the coherence length thereof;

FIG. 4 is a wavelength spectrum of the light source of the invention; and

FIG. 5 is a diagram of interference intensity of the invention versus the coherence length thereof.

### DETAILED DESCRIPTION OF THE INVENTION

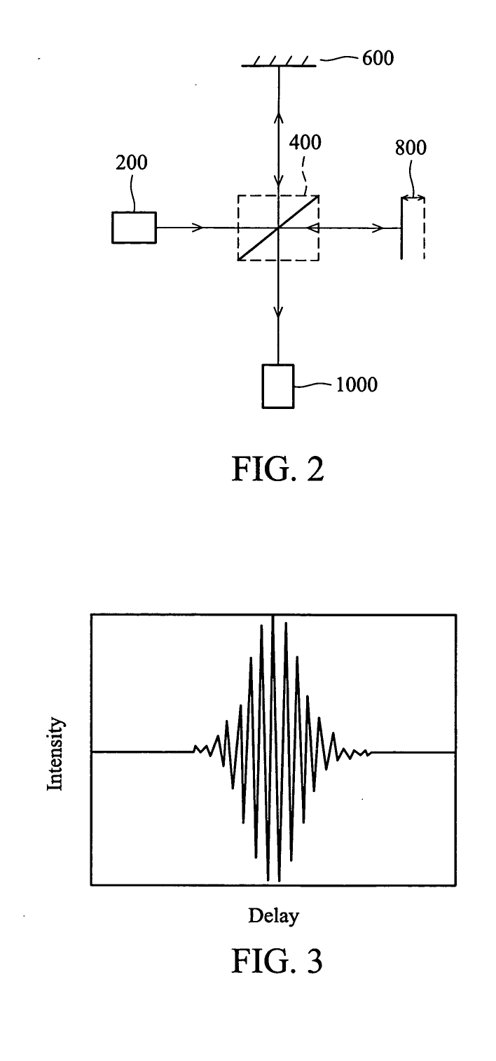

The concept of a conventional Michelson interference system is adapted in the invention, wherein as shown in FIG. 2, 200 is a light source, 400 is an interferometer, 600 is a reflective mirror, 800 is a sample and 1000 is a detector.

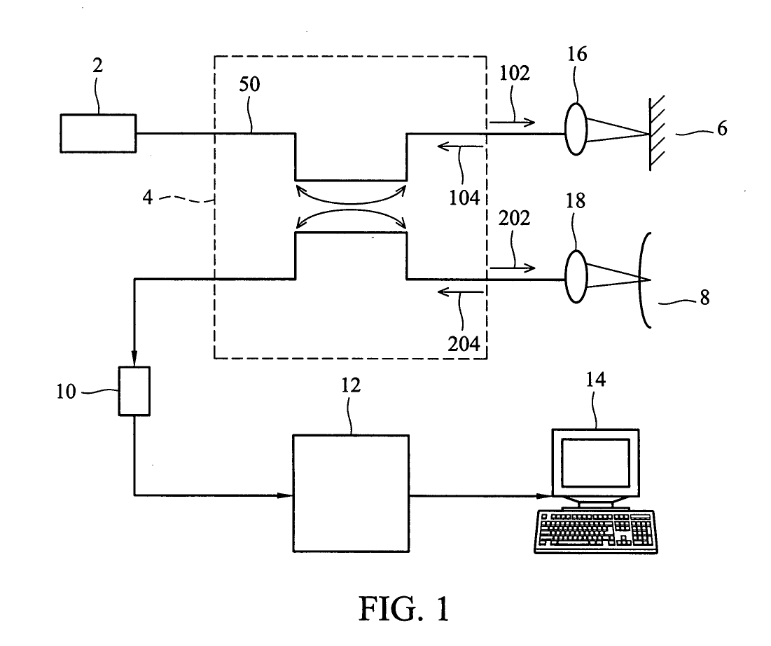

As shown in FIG. 1, the light source 2 emits short wavelength light converted to act as a first beam 50 by passage through appropriate phosphor. The first beam 50 is split into a second beam 102 and a third beam 202 by an interferometer 4. The second beam 102 is focused by a lens 16 and reflected by a reflective mirror 6 to act as a reference beam 104. The third beam 202 is focused by a lens 18 and reflected by a measurement object 8 to create a fourth beam 204. The fourth beam 204 is interferomtrically combined with the reference beam 104 in the interferometer 4. A detector 10 converts the interference fringe applied as an optical signal to an electronic signal, processed by a processing unit 12 to generate video images of the measurement object 8 to be displayed on the computer 14.

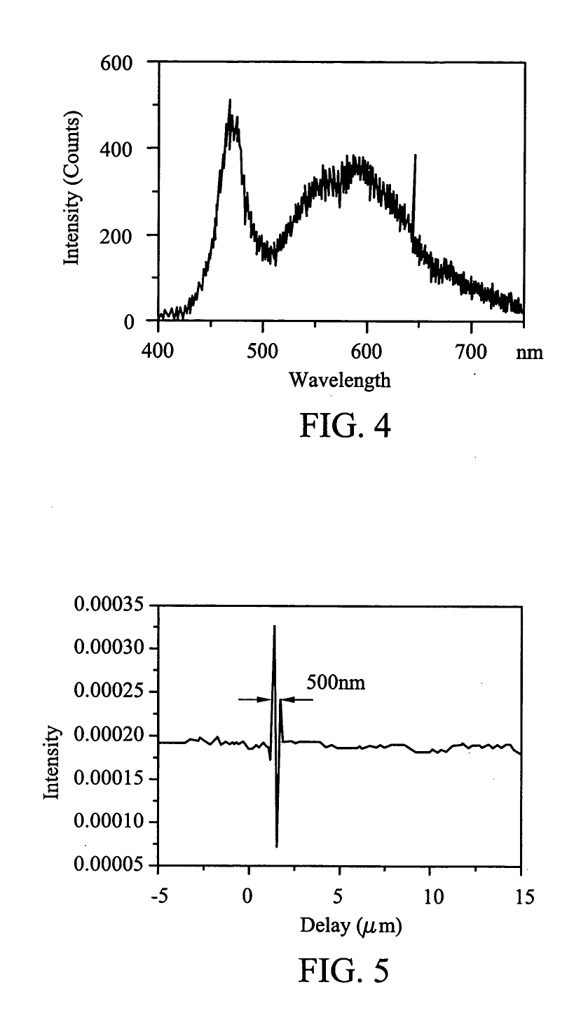

In this embodiment, a commercial white LED composed of blue light GaN LED and YAG phosphor acts as the light source 2 emitting the first beam 50. As shown in FIG. 4, the wavelength spectrum of the light source 2 ranges from 400 nm to 700 nm. The interference intensity versus the coherence length (longitudinal resolution) of the invention is shown in FIG. 5. An ultra-high resolution of 500 nm (0.5 μm) in atmosphere and even higher resolution of 385 nm in water (optical refraction rate is 1.3) is obtained. Compared with conventional OCT (interference intensity versus coherence length thereof shown in FIG. 5), the present invention improves considerably over the conventional technology.

White LED can also comprise an ultraviolet LED and phosphor resulting in red, blue, and green light.

As described above, the light source in the invention provides broader wavelength spectrum than conventional means, such that ultra-short coherence length can be obtained, providing resolution of sub-micrometer scale for more precise inspection.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scale of the appended claims should be accorded the broadest interpretation so as to encompass all such modifications and similar arrangements.

What is claimed is:

1. A sub-micrometer-resolution optical coherence tomography device, comprising:
a light source emitting short wavelength light converted to a first beam with a broad wavelength spectrum by passage through phosphor;
an interferometer splitting the first beam into a second beam and a third beam; and
a reflective mirror reflecting the second beam to act as a reference beam;
wherein the third beam is reflected by the object to create a fourth beam interferometrically combined with the reference beam in the interferometer to provide interference fringes applied as an optical signal.

2. The sub-micrometer-resolution optical coherence tomography device as claimed in claim 1, wherein the wavelength spectrum width of the light source is hundreds of nanometers.

3. The sub-micrometer-resolution optical coherence tomography device as claimed in claim 1, wherein the first beam achieves near infrared wavelength.

4. The sub-micrometer-resolution optical coherence tomography device as claimed in claim 1, wherein the light source is a light emitting diode.

5. The sub-micrometer-resolution optical coherence tomography device as claimed in claim 4, wherein the first beam comprises white light.

6. The sub-micrometer-resolution optical coherence tomography device as claimed in claim 4, wherein the wavelength spectrum of the light source is from 400 nm to 700 nm.

7. The sub-micrometer-resolution optical coherence tomography device as claimed in claim 4, wherein the first beam is produced by a GaN light emitting diode and YAG phosphor.

8. The sub-micrometer-resolution optical coherence tomography device as claimed in claim 4, wherein the first beam is produced by an ultraviolet light emitting diode and phosphor resulting in red, blue and green light.

9. The sub-micrometer-resolution optical coherence tomography device as claimed in claim 1, wherein the light source is a blue LED.

10. The sub-micrometer-resolution optical coherence tomography device as claimed in claim 1, wherein the light source is an ultraviolet LED.

11. The sub-micrometer-resolution optical coherence tomography device as claimed in claim 1 further comprising a detector converting the optical signal received from the interferometer to an electronic signal.

12. The sub-micrometer-resolution optical coherence tomography device as claimed in claim 11, further comprising a signal processing unit processing electronic signal converted by the detector.
